(19) United States
(12) Patent Application Publication
(10) Pub. No.: US 2026/0004053 A1
(43) Pub. Date: Jan. 1, 2026

(54) WORKFLOW OBJECT FOR REPEATABLE GENERATIVE ARTIFICIAL INTELLIGENCE

(71) Applicant: Rowan TELS Corp., Ann Arbor, MI (US)

(72) Inventors: Benjamin DEMBOSKI, Seattle, WA (US); Chad KIRBY, Tumwater, WA (US); David BILLMAIER, Redmond, WA (US); Laura BERWICK, Seattle, WA (US); Andrew STEWART, Seattle, WA (US)

(73) Assignee: Rowan TELS Corp., Ann Arbor, MI (US)

(21) Appl. No.: 19/244,086

(22) Filed: Jun. 20, 2025

Related U.S. Application Data
(60) Provisional application No. 63/664,379, filed on Jun. 26, 2024.

(51) Int. Cl. G06F 40/166; G06F 40/143

(52) U.S. Cl. CPC G06F 40/166; G06F 40/143

(57) ABSTRACT

Machines, media, and processes to form and embed one or more generative workflow objects in a structured document. A generative workflow object is associated with input content associated with a source region of the structured document and an output content associated with a destination region of the structured document. A prompt is generated based on the generative workflow object and provided to an artificial intelligence (AI) model to generate the output content based on the input content. The generative workflow object is updated based on interactions with the AI model and used to generate future prompts to enable repeatable regeneration of the output content in response to changes to content in the source region and/or the destination region.

### CROSS-REFERENCE TO RELATED APPLICATIONS

This U.S. non-provisional application claims priority to U.S. provisional application 63/664,379, entitled “REPEATABLE GENERATIVE WORKFLOW OBJECT,” and filed Jun. 26, 2024, the entirety of which is incorporated herein by reference.

### BACKGROUND

Generative artificial intelligence (GenAI) shows promise as a mechanism to improve human user productivity for certain tasks. GenAI employs artificial intelligence (AI) models to generate content, such as text, images, audio, code, or video, based on a prompt. For example, AI models may be used to generate a summary of a piece of content. GenAI improves user productivity by automating some tasks in the content creation process.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, apparatuses, and computer program products are disclosed for performing repeatable content generation using a generative workflow object embedded in a structured document. Input content from a source region of a structured document is provided to an artificial intelligence (AI) model to generate output content for a destination region of the structured document. Contextual information related to interactions with the AI model are maintained in a generative workflow object. Repeatable regeneration of the output content is performed based at least in part on the generative workflow object.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for embedding a generative workflow object in a structured document, in accordance with an embodiment.

FIG. 2 depicts a block diagram of an example system for performing repeatable content generation using a generative workflow object embedded in a structured document, in accordance with an embodiment.

FIG. 3 depicts a flowchart of a process for embedding a generative workflow object in a structured document, in accordance with an embodiment.

FIG. 4 depicts a flowchart of a process for prompting a user to regenerate content for a destination region based on detection of changes to a source region, in accordance with an embodiment.

FIG. 5 depicts a flowchart of a process for performing repeatable content generation using a generative workflow object embedded in a structured document, in accordance with an embodiment.

FIG. 6 depicts a flowchart of a process for generating a prompt and validating a response based on a content criterion, in accordance with an embodiment.

FIG. 7 depicts a flowchart of a process for validating a response from an AI model based on a content criterion, in accordance with an embodiment.

FIG. 8 depicts a flowchart of a process for updating a generative workflow object based on user feedback, in accordance with an embodiment.

FIG. 9 depicts a block diagram of an example a computer system within which a set of instructions may be executed for causing the computer system to perform any one or more of the methodologies discussed herein, in accordance with an embodiment.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

GenAI improves user productivity by automating certain tasks during the content creation process. For instance, when creating a document, such as, but not limited to, a paper, a website, or the like, a user may interact with an AI model to generate content for a section of the document. The user may provide to the AI model a prompt to generate the content based on input content (e.g., content from another section of the document, underlying data). For example, a user may prompt the AI model to generate an abstract based on another section of the document, or an infographic based on underlying data associated with the document. The user receives, from the AI model, a response containing the generated content. After receiving the generated content, the user may review the generated content for accuracy and/or compliance with a content constraint (e.g., word count limits). If the generated content is inaccurate and/or does not satisfy a content constraint, the user may manually edit the generated content and/or provide a follow-up prompt to the AI model to regenerate the content. When input data used to generate the content changes, the generated content may be out-of-sync with other sections of the document. For instance, when a user edits the document, an abstract generated based on the document may no longer be an accurate summary of the document. Similarly, when underlying data associated with the document is updated, an infographic generated based on the underlying data may no longer be accurate. In such situations, the user typically would need to regenerate the content by repeating the steps described above.

Embodiments disclosed herein are directed to a generative workflow object that stores contextual information related to AI-generated content that may be activated to generate and/or regenerate output content for a destination portion of a structured document based on input content from a source portion of the structured document. The generative workflow object maintains contextual information, such as, but not limited to, an input content used to generate the output content, a source region of the structured document comprising the input content, a transformation to apply to the input content to generate the output content, a destination region of the structured document associated with the output content, a content constraint for the output content, a parameter to tune the generation of the output content, historical interactions (e.g., prompt, response) with an AI model, user edits to the generated content, and/or the like. An AI assistant employs information maintained in the generative workflow object to generate prompts that are provided to the AI model to automate interactions with the AI model. For instance, the AI assistant includes contextual information (e.g., historical interactions) in a prompt to reduce the need to provide follow-up prompts to the AI model. The generative workflow object is stored within a structured document file, and activated to regenerate AI-generated content, supporting more efficient and effective construction of a structured document file in a computer system.

The AI assistant validates the generated content based on parameters and/or constraints in the generative workflow object. For instance, the AI assistant checks the generated content for compliance with a word count limit (e.g., greater than 50 words, less than 150 words, etc.) associated with the generative workflow object. If generated content fails to comply with a parameter and/or constraint, the AI assistant automatically generates a follow-up prompt to request the AI model to regenerate the content based on the parameter and/or constraint. Once the generated content is validated, the AI assistant automatically populates a destination region of the structured document with the generated content, and/or provides the generated content to a user through a user interface (UI) element (e.g., chat window).

In embodiments, the AI assistant monitors the structured document for changes (e.g., edits, etc.) to determine when to regenerate content. For instance, the AI assistant determines whether edits to one or more regions (e.g., source region, etc.) of the structured document changes the context of the content in the region since the last time the generated content was generated. In an embodiment, the AI assistant determines whether a number of words changed since the last time the generated content was generated exceeds a wordcount threshold. In another embodiment, the AI assistant determines whether a distance (e.g., cosine distance, Euclidean distance, etc.) between a first vector representation associated with a previous content in the source region and a second vector representation associated with a current content in the source region exceeds a distance threshold. When the AI assistant determines that changes to the source region of the structured document satisfies a threshold condition (e.g., wordcount threshold, distance threshold, etc.), the AI assistant prompts a user to regenerate the content for the destination region and/or automatically interacts with an AI model to regenerate the content for the destination region.

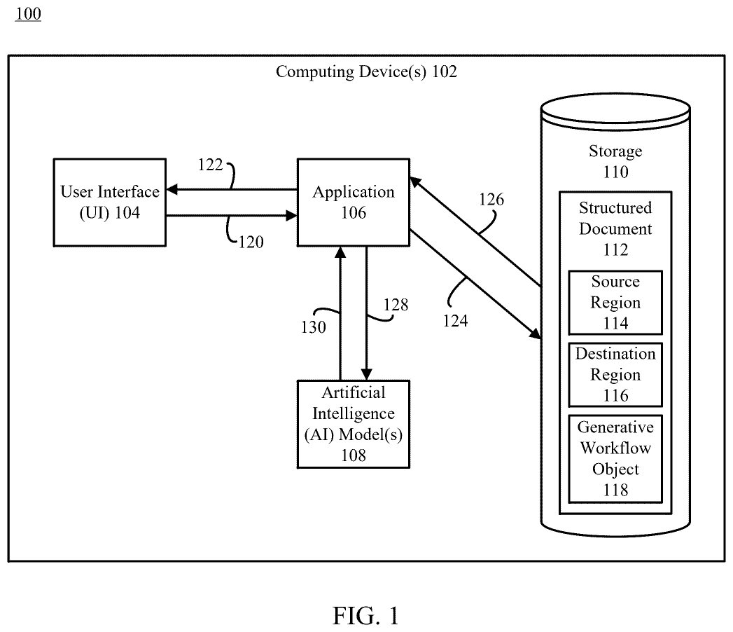

Implementations for these and further embodiments are described in further detail as follows. For example, FIG. 1 shows a block diagram of an example system 100 for embedding a generative workflow object in a structured document, in accordance with an embodiment. As shown in FIG. 1, system 100 includes one or more computing devices 102 comprising a UI 104, an application 106, one or more AI models 108, and a storage 110. In system 100, storage 110 comprises a structured document 112 that includes a source region 114, a destination region 116, and a generative workflow object 118. System 100 is described in further detail as follows.

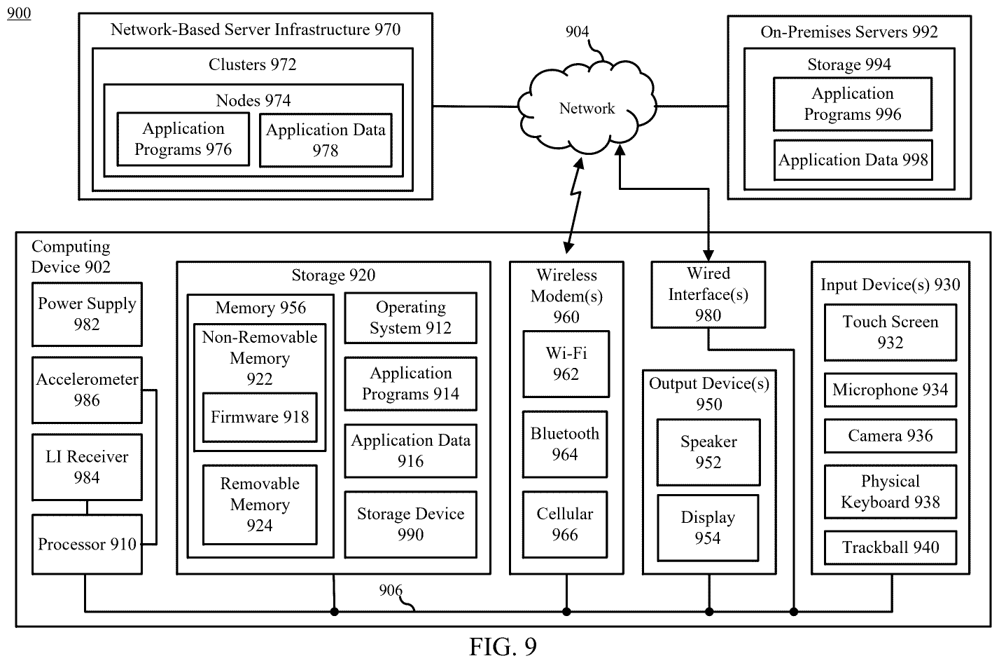

Computing device(s) 102 comprise any type of stationary or mobile processing system, such as, but not limited to, a mobile or handheld device, a personal computer, a laptop, a tablet, a server, and/or any combination thereof. In embodiments, the elements of computing device(s) 102 are implemented across a plurality of computing device(s) 102 (e.g., client, server, database, etc.) that are communicatively coupled via one or more communications networks (not depicted). Various example implementations of computing device(s) 102 are described below in reference to FIG. 9 (e.g., computing device 902, on-premises servers 992, network-based server infrastructure 970, and/or components thereof).

A user interacts with system 100 via UI 104. UI 104 comprises any type of interface capable of interacting with application 106, such as, but not limited to, a graphical user interface (GUI), a command line interface (CLI), a voice user interface (VUI), a human interface, an input/output (I/O) device (e.g., mouse, keyboard, touchscreen, digitizer, microphone, speaker, etc.), and/or any combination thereof. In embodiments, UI 104 comprises interface elements, such as, but not limited to, buttons, dials, sliders, windows, and/or the like. A user interacts with application 106 by providing a user input 120 to application 106 via UI 104, and receiving outputs 122 from application 106 via UI 104.

In a configuration, UI 104 comprises a chat interface that allows a user to interact with an AI assistant and/or AI model(s) 108. An AI assistant provides the chat interface to enable the user to conduct a chat session with AI model(s) 108 that is iteratively updated to form a generative workflow object 118. UI 104 further enables in-line generation functions in a UI of structured document 112 based on the inputs (e.g., prompts), transformation (e.g., generation operations performed by AI model(s) 108), and/or outputs achieved through the chat session. In embodiments, when the user sends a new message to AI model(s) 108 (e.g., by clicking a Send button) via the chat interface, a prompt is generated based on the sent message and related chat history (e.g., historical interactions with AI model(s) 108 and the generated prompt provided to the AI model(s) 108. UI 104 further present UI elements (e.g., buttons) to the user in association with an element (e.g., destination region 116, etc.) of structured document 112 to allow a user to select input content (e.g., content from source region 114) as a content source for generating content for the associated element. In an embodiment, UI 104 enables a user to provide placeholder inputs, such as “region 1,” to identify a region (e.g., source region 114) of structured document 112 that has not yet been drafted to act as the basis for future output content generation after the content for “region” is drafted.

In embodiments, the AI assistant presents the output content generated by AI model(s) 108 as text in the chat interface of UI 104. This enables the user to move (e.g., copy and paste) the text from the chat interface to destination region 116 in structured document 112. In configurations, AI assistant automatically populates the generated output content at the location (e.g., destination region 116) where the content generation was invoked, or prompts the user to identify a desired destination (e.g., destination region 116). In an instance, generative workflow object 118 specifies the destination location where the output content may be automatically populated.

Application 106 enables a user to manipulate (e.g., generate, edit, etc.) structured document 112. Application 106 comprises any type of application, such as, but not limited to, a mobile application, a desktop application, a server application, an online application, a cloud-based application, a word processer, a spreadsheet application, a presentation application, a multimedia application, a web browser, a plugin, a servlet, an applet, a script, and/or any combination thereof. In embodiments, a user interacts with application 106 to manually generate and/or edit content in structured document 112, and/or to automatically and/or semi-automatically generate content for structured document 112 via AI model(s) 108.

Application 106 interacts with AI model(s) 108 to generate content structured document 112. For instance, application 106 generates a prompt 128 based on generative workflow object 118, provides prompt 128 to AI model(s) 108, and receives a response 130 that includes generated output content from AI model(s) 108. In embodiments, application 106 generates prompt 128 based generative workflow object 118. Prompt 128 comprises a request (e.g., a natural language request) to perform a task (e.g., summarize content, generate an infographic, etc.) based on content in source region 114. In instances, application 106 guides AI model(s) 108 in the generation of the output content by including contextual information in prompt 128. Examples of contextual information in prompt 128 include, but are not limited to, historical interactions (e.g., prompt, response, etc.) with AI model(s) 108, content in source region 114, content in destination region 116, user modifications to content in source region 114, user modifications to content in destination region 116, user feedback, output content constraints (e.g., wordcount limits), and/or any combination thereof.

Application 106 validates output content generated by AI model(s) 108 based on parameters and/or constraints in generative workflow object 118. For instance, application 106 compares a wordcount of output content generated by AI model(s) 108 against a wordcount limit in generative workflow object 118, or compares a characteristic (e.g., dimension, resolution, color, etc.) of an infographic against an infographic constraint in generative workflow object 118. If application 106 determines that output content generated by AI model(s) 108 fails to meet a parameter and/or constraint, application 106 generates a follow-up prompt 128 to request the regeneration of the output content by AI model(s) 108. After successful validation of the output content in response 130, application 106 automatically populates destination region 116 with the generated output content and/or provides the generated output content to the user via UI 104 to enable the user to insert (e.g., copy-and-paste) the generated output content into destination region 116.

AI model(s) 108 comprise any generative AI model capable of generating content (e.g., text, image, audio, video, multimedia, code, etc.), such as, but not limited to, a language model, a diffusion model, a generative adversarial network (GAN), a transformer model, an autoencoder, an autoregressive model, and/or the like. In embodiments, AI model(s) 108 comprises a local AI model executing on a user device and/or a remote AI model executing on one or more servers. In instances, application 106 employs different AI model(s) 108 in different scenarios. For instance, application 106 employs different AI model(s) 108 based on the type of output content for destination region 116. Furthermore, when one or more AI model(s) 108 are unavailable (e.g., offline), application 106 can employ different (e.g., local, etc.) AI model(s) 108. Contextual information in generative workflow object 118 enables application 106 to easily switch between AI model(s) 108 to regenerate output content for destination region 116. For instance, application 106 can generate output content using a plurality of AI model(s) 108 in order to provide a user the option to select from different versions of the generated output content generated by different AI model(s) 108.

Storage 110 comprises any type of local or remote memory capable of storing files, including, but not limited to, internal memory, external memory, cloud-based storage, server-based storage, and/or the like. Application 106 interacts with structured document 112 by reading data 126 from storage 110, and by writing updates 124 to storage 110. Various example implementations of storage 110 are described below in reference to FIG. 9 (e.g., storage 920, storage 994, and/or components thereof).

Storage 110 stores structured document 112. Structured document 112 comprises any electronic file that is organized using a defined format. In instances, the format of structured document 112 is defined using markup language by using tags to define components (e.g., content, formatting, etc.) of structured document 112 and their relationships. Structured document 112 comprise files in various formats, such as, but not limited to, extensible Markup Language (XML), Document Open XML (DOCX), Portable Document Format (PDF), HyperText Markup language (HTML), JavaScript Object Notation (JSON), and/or any proprietary format.

As shown in FIG. 1, structured document 112 includes source region 114, destination region 116, and generative workflow 118. Source region 114 comprises any contiguous or non-contiguous portion (e.g., section, page, paragraph, table, sentence, etc.) of structured document 112. Content (e.g., input content) in source region 114 is used to generate output content for placement in destination region 116. The input content in source region 114 and/or the generated output content comprise content in any format, such as, but not limited to, text, image, audio, video, and/or any combination thereof. While FIG. 1 depicts single instances of source region 114, destination region 116, and generative workflow object 118, structured document 112 can include additional instances of source region 114, destination region 116, and/or generative workflow object 118. For instance, structured document 112 can include a source region 114 and/or a destination region 116 for each piece of generated output content, and/or a generative workflow object 118 for each destination region 116.

Generative workflow object 118 comprises a construct that maintains information associated with AI content generation. Generative workflow object 118 maintains information (e.g., contextual information, metadata, etc.) associated with regions (e.g., source region 114, destination region 116, etc.) of structured document to preserve consistency across revisions of interrelated parts of the structured document. Generative workflow object 118 enables automated workflows for creating, updating, and/or validating content in a region (e.g., source region 114, destination region 116, etc.) structured document 112 against content in another region of structured document 112 and against parameters and/or constraints with structured document 112 and/or a region thereof. Application 106 employs generative workflow object 118 to interact with AI model(s) 108, make procedural calls to algorithmic code, and/or utilize other mechanisms of generating content in structured document 112.

In embodiments, generative workflow object 118 functions as a container for (a) inputs to an underlying generative mechanism, (b) metadata identifying and describing source portions of a document file comprising those inputs, (c) parameters applied to tune an underlying generative mechanism, and (d) intermediate generated results (e.g., generated output content) in multi-step generative workflows. In instances, generative workflow object 118 stores source inputs (e.g., input content in source region 114) to the generative workflow object directly in generative workflow object 118 as text, images, vectorized drawings, or other content, and/or references the source inputs (e.g., input content in source region 114) using a unique identifier encoding a characteristic (e.g., position, location, role, purpose, etc.) of the source inputs within structured document 112.

In instances where application 106 generates output content by invoking AI model(s) 108, generative workflow object 118 maintains historical interactions (e.g., prompts, responses, conversation history, etc.) between application 106 and AI model(s) 108. Application 106 updates generative workflow object 118 with input (e.g., prompts, etc.) provided to AI model(s) 108, outputs (e.g., responses, generated output content, etc.) generated by AI model(s) 108, and/or a user feedback (e.g., modifications of content in source region 114, modification of output content generated by AI model(s) 108, selection of a preferred version of generated content, etc.).

Generative workflow object 118 is organized (e.g., formatted) in various manners. In embodiments where generative workflow object 118 is used with a model-driven chat interface, generative workflow object 118 comprises one or more programmatic code classes that define various elements, such as, but not limited to, an initial message (i.e., prompt instruction) that instructs AI model(s) 108 on the purpose of the prompt (e.g., generating a particular type of content), a name and/or identifier of AI model(s) 108, a construct (e.g., array, etc.) that stores messages (e.g., prompts, etc.) sent to and/or messages (e.g., responses, etc.) received from AI model(s) 108, a validation method that checks the generated output content for rule (e.g., output content constraint, etc.) violations, a serialization method for converting the chat session (e.g., historical interactions with AI model(s) 108) into a format for storage, and/or a unique identifier for the chat session (e.g., historical interactions with AI model(s) 108). Generative workflow object 118 identifies (e.g., stores) the content of source region 114, and/or the location (e.g., identifier) of source region 114 within structured document 112 to enable the content of source region 114 to act as a starting point or source of truth for the content generation process that can be monitored for changes to trigger the content regeneration process.

Generative workflow object 118 may include task-related elements that are annotated for a specific task. For example, an annotation can specify the generation of a natural language summary in a formal, professional voice, and having a length of between 50 and 150 words. In embodiments, annotations to source region 114 are automatically generated when content generation is performed based on interconnected generative workflow objects 119. For instance, in a multi-step workflow a first generative method is run based on a first generative workflow object 118 to generate a first output content, and then based on an automated analysis of the first output content, a second generative method is performed based on a second generative workflow object 118 with the first output content as an input. As an example, when a first generative workflow object 118 is employed to generate a first output content having a 50-150 word count and AI model(s) 108 returns output content having 160 words, a second generative workflow object 118 is employed to automatically provide a second prompt to AI model(s) 118 to regenerate a second output content with a shorter length (e.g., under 150 words).

In instances, generative workflow object 118 is hard-coded (e.g., pre-configured in software logic or data structures) with initial messages (e.g., prompts, prompt instructions, etc.) or sets of initial messages to guide a user in employing generative workflow object 118 to interact with AI model(s) 108. In one embodiment, generative workflow object 118 includes different initial messages (e.g., prompts, prompt instructions, etc.) for different AI model(s) 108. For example, generative workflow object 118 includes a first set of initial messages (e.g., prompts, prompt instructions, etc.) for interacting with a remote AI model(s) 108, and a second set of messages (e.g., prompts, prompt instructions, etc.) for interacting with a locally-executed model. The initial message (e.g., prompts, prompt instructions, etc.) included in generative workflow object 118 is determined based on various factors, such as, but not limited to, based on a user selection, a setting, availability of AI model(s) 108, availability of content-generation algorithms, an input content type associated with input content in source region 114, an output content type associated with output content to be generated, and/or the like.

In embodiments, application 106 generates and embeds generative workflow object 118 based on a detected relationship between regions of structured document 112. For instance, application 106 determines that content in source region 114 is related to content in destination region 116 by detecting the placement of output content generated by AI model(s) 108 based on input content from source region 114 into destination region 116. Application 106 configures workflow object 118 with one or more messages (e.g., prompts, prompt instructions, etc.) to provide, to AI model(s) 108, the original contents from source region 114f and destination region 116, and request generation of new (e.g., updated) output content for destination region 116 based on new and/or modified content from source region 114 and/or destination region 116.

In an embodiment, application 106 determines that content in source region 114 is related to content in destination region 116 by analyzing existing content in a structured document for semantic relationships (e.g., similarities). For instance, application 106 determines a relationship between content in a first portion (e.g., destination region 116) of structured document 112 and content in a second portion (e.g., source region 114) of structured document 112 that indicates that content in the first portion could have been generated from content in the second portion. Application 106 generates generative workflow object 118 based on the first portion (e.g., source region 114), the second portion (e.g., destination region 116), and the determined relationship between content in a first portion (e.g., destination region 116) of structured document 112 and content in a second portion (e.g., source region 114) of structured document 112. Application 106 configures workflow object 118 with one or more messages (e.g., prompts, prompt instructions, etc.) to provide, to AI model(s) 108, the original contents from the first portion (e.g., source region 114) of structured document 112 and the second portion (e.g., destination region 116) of structured document 112, and request generation of new (e.g., updated) output content for the second portion (e.g., destination region 116) of structured document 112 based on new and/or modified content from the first portion (e.g., source region 114) of structured document 112 and/or the second portion (e.g., destination region 116) of structured document 112.

In embodiments, generative workflow object 118 is preconfigured prior to content generation. For instance, preconfigured generative methods (e.g., desired content generation, desired content transformation, etc.) for potential generative workflow objects can be referenced to generate generative workflow object 118 that includes the identified source content, and a unique identifier that references the preconfigured generative method. For a structured document 112 having a known relationship between two or more portions (e.g., source region 114, destination region 116) of the document, application 106 can create a preconfigured generative workflow object 118 even in the absence of content in structured document 112. By preconfiguring generative workflow object 118, content for destination region 116 can be immediately generated when source content is populated into source region 114.

Generative workflow object 118 can be preconfigurable for various tasks, such as, but not limited to, content summarization, content reformatting, content validation, infographic generation, and/or the like. In instances, a preconfigured generative workflow object 118 is customizable by a user via UI 104 by, for example, but not limited to, adding desired parameters (e.g., wordcount limits, output content characteristics, etc.) to the generative method, adding sequential or causal linkages between generative workflow objects 118, providing unique identifiers for locations (e.g., source region 114, destination region 116, etc.) in the structured document 112, and/or other customizations. In an embodiment, generative workflow object 118 comprises a default preconfigured document context. For example, generative workflow object 118 may, by default, utilize content in a particular region (e.g., introduction section, conclusion section, etc.) of structured document 112, or utilize the entirety of structured document 112 as context for AI model(s) 108. A user may elect to keep the default configuration (e.g., generative method, source content, and/or context), or the user may customize generative workflow object 118 by selecting a different generative method and/or selecting different sections of structured document 112 for the source content and/or context.

In configurations, UI 104 comprises an interface to enable a user in constructing a custom generative workflow object 118 from scratch (e.g., not from a preconfigured generative workflow object) using building blocks provided based on the type of structured document they wish to create, or from model prompts previously used successfully to produce the desired output content. UI 104 enables a user to construct interconnected (e.g., compound, sequentially linked, etc.) generative workflow objects to perform compound tasks, such as, but not limited to, reformatting a summary as a list of bullet points and ensuring that each bullet point has a consistent structure. An interconnected or compound generative workflow object 118 enables the preconfiguration and/or automation of existing drafting workflows within a structured document or within a document drafting environment.

In instances where generative workflow object 118 comprises a validation step, application 106 validates output content generated by AI model(s) 108 to ensure that the generated output content satisfies an output content criteria. When generated output content fails validation, application 106 automatically provides follow-up messages and/or commands (e.g., prompts) to AI model(s) to regenerate the output content.

Generation of content based on generative workflow object 118 can be initiated automatically without any input from the user, manually in response to an explicit user request, and/or semi-automatically based on a user response to a prompt. For instance, application 106 prompts a user by providing an alert to a user indicating that input content in source region 114 has changed and offering the user an option to invoke regeneration of content for destination region 116 based on generative workflow object 118. In an embodiment, application 106 automatically regenerates content for destination region 116 based on generative workflow object 118 in response to changes in the content in source region 114.

A generative workflow object may be embedded within the structured document with the various components it stores identified and annotated. If the same task is initiated using a different portion of the document, or if the original source content such as a text string is altered, the generative workflow object may be responsively executed automatically or by user initiation, replacing the originally-generated output in the document with the updated content. In this manner, the generative workflow object may operate to replace previous output data with an updated version, maintaining related content consistent across the structured document.

Content generated based on generative workflow object 118 is populated into destination region 116 in various ways. For instance, the generated output content can be provided for the user via UI 104 to copy and paste into destination region 116 of structured document 112. In an embodiment, generative workflow object 118 includes a destination identifier associated with destination region 116, and the generated output content may be automatically populated into destination region 116 based on the destination identifier associated with destination region 116. Application 106 may prompt a user to identify a desired destination region (e.g., destination region 116) of structured document 112 as a target for the generated output content. The generated output content may be provided via UI 104 to allow the user to populate a desired destination region of structured document 112. Other mechanisms for populating destination region 116 of structured document 112 with the generated output content that are well understood by those of ordinary skill in the art may be provided by the document drafting application or environment user interface, and/or dynamically displayed when generating content using generative workflow object 118.

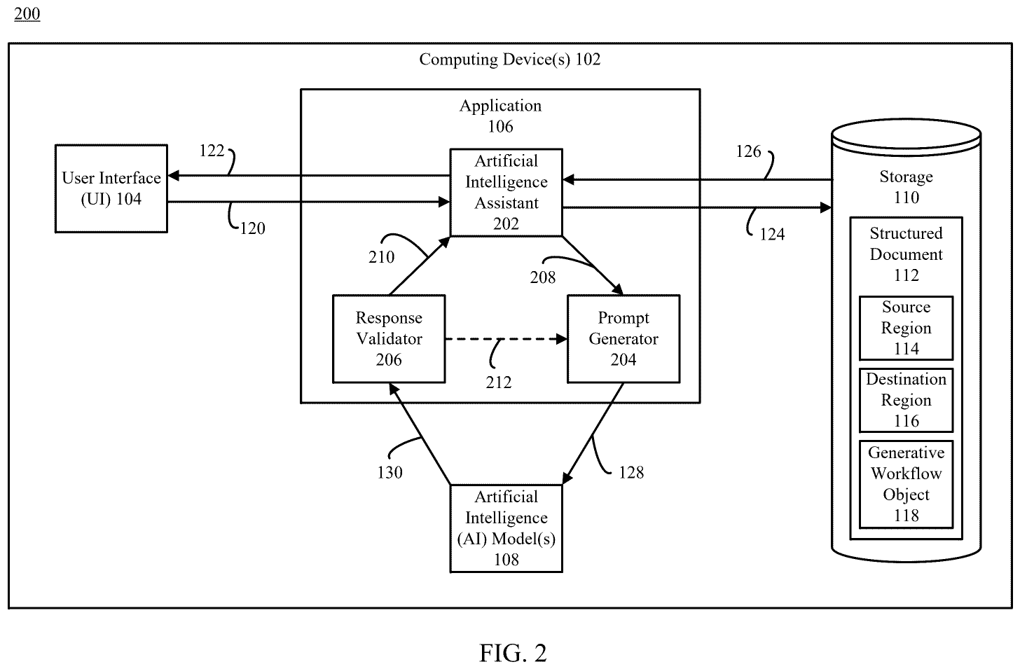

Embodiments described herein may operate in various ways to perform repeatable content generation using a generative workflow object embedded in a structured document. For example, FIG. 2 depicts a block diagram of an example system 200 for performing repeatable content generation using a generative workflow object embedded in a structured document, in accordance with an embodiment. As shown in FIG. 2, system 200 includes computing device(s) 102, UI 104, application 106, AI model(s) 108, storage 110, structured document 112, source region 114, destination region 116, and generative workflow object 118. In system 200, application 106 further includes an AI assistant 202, a prompt generator 204, and a response validator 206. System 200 is described in further detail as follows.

AI assistant 202 is configured to facilitate the repeatable generation of output content for destination region 116 based on input content in source region 114. AI assistant 202 comprises any type of application, such as, but not limited to, a mobile application, a desktop application, a server application, an online application, a cloud-based application, a plugin, a servlet, an applet, a script, and/or any combination thereof. In an embodiment, AI assistant 202 is embedded within a structured document creation application or environment, such as, but not limited to, a word processing application, a spreadsheet application, a presentation application, a web editor, and/or a code editor. In an embodiment, interactions with AI assistant 202 are enabled via elements of UI 104, such as, but not limited to, an interactive side panel in application 106, companion window, and/or or similar user interface, to offer access to AI-powered generation functions. In another embodiment, interactions with AI assistant 202 are enabled in-line in the UI of the structured document creation application or environment to allow a user to invoke AI-related operations as the user creates the structured document. In an application where specific entry fields are provided for defined regions of structured document 112, suggestions offered by AI assistant 202 may be tailored to the region the user is actively working in.

In embodiments, AI assistant 202 employs a support group approach to prompt AI model(s) 108 to generate content for additional sections (e.g., destination region 114) of structured document 112 based on an input region (e.g., source region 114) of document 112. For example, to generate content for a given input region (e.g., source region 114), AI assistant employs one or more generative workflow objects 118 to perform a series of tasks to generate output content for destination region 116 and/or suggest related content for that input region. In one embodiment, AI assistant 202 first prompts AI model(s) 108 for a list of concepts that may need to be described in greater detail to adequately support content in source region 114. AI assistant 202 then provides a follow-up prompt to AI model(s) 108 to organize the list of concepts into a logical topical order or outline. The elements of the outline may correspond to regions of structured document 112 that are monitored and validated for completion. For example, AI assistant 202 monitors a completion field (e.g., UI element) in structured document 112 for user interaction to determine completion of source region 114. In response to an indication of completion of source region 114, the outline of items updated, and completion of the structured document is indicated when all of the completion fields indicate source regions 114 are complete. AI assistant 202 then provides another follow-up prompt to AI model(s) 108 to generate content that further elaborates on the items in the outline. In instances, AI assistant 202 prompts the user to accept, reject, and/or request changes to the generated output content. AI assistant 202 captures user instructions and/or interactions to update and/or improve generative workflow object 118.

In embodiments, AI assistant 202 generates and embeds generative workflow object 118 in structured document 112. AI assistant 202 detects changes in the content of source region 114 and/or destination region 116 to determine whether content in destination region 116 needs to be generated or regenerated. Based on detected changes to content in source region 114, AI assistant automatically or semi-automatically causes prompt generator 204 to initiate the generation of output content for destination region 116. For instance, AI assistant 202 provides a command 208 to prompt generator 204 to cause prompt generator 204 to generate prompt 128 and provide prompt 128 to AI model(s) 108.

Prompt generator 204 is configured to generate prompt 128 based on generative workflow object 118, and provide prompt 128 to AI model(s) 108 to generate output content for destination region 116. In embodiments, prompt generator 204 generates prompt 128 based on historical interactions (e.g., prompts, responses, etc.) with AI model(s) 108, changes to content in source region 114, previous user feedback on generated output content of destination region 116, parameters (e.g., output content constraints) associated with generative workflow object 118.

Response validator 206 is configured to receive a response 130 from AI model(s) 108, and validate output content generated by AI model(s) 108 based on parameters (e.g., output content constraints) associated with generative workflow object 118. For instance, response validator may determine whether a wordcount of output content generated by AI model(s) 108 satisfies a wordcount limit. When the generated output content fails validation, response validator 206 may provide validation feedback 212 to prompt generator 204 to enable prompt generator 204 to generate a follow-up prompt 128 for transmission to AI model(s) 108. When the generated output content is successfully validated, response validator 206 provides the generated output content to AI assistant 202 as output content 210.

AI assistant 202 is further configured to receive output content 210 from response validator 206, and populate destination region 116 with output content 210. In instances, AI assistant provides output content 210 to a user via UI 104 to enable the user to populate destination region 116 with output content 210. For instance, UI 104 displays output content 210 in a prompt that allows a user to approve output content 210 for insertion into destination region 116. In an embodiment, UI 104 displays output content 210 in UI 104 to enable the user to insert (e.g., copy-and-paste) output content 210 into destination region 116. In a configuration, AI assistant 202 automatically inserts output content 210 into destination region 116. In embodiments, AI assistant 202 manages generative workflow object 118 based on prompt 128, response 130, validation feedback 212, and/or user inputs 120.

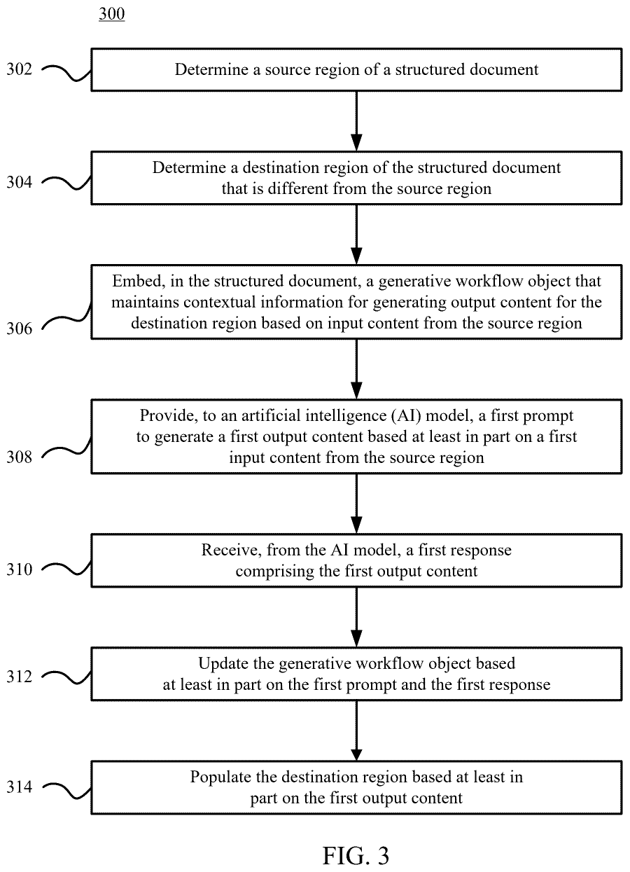

Embodiments described herein may operate in various ways to embed a generative workflow object in a structured document. For example, FIG. 3 depicts a block diagram of an example system 300 for embedding a generative workflow object in a structured document, in accordance with an embodiment. Computing device(s) 102, application 106, AI assistant 202, prompt generator 204, and/or response validator 206 may operate in accordance with flowchart 300. Note that not all steps of flowchart 300 may need to be performed in all embodiments, and in some embodiments, the steps of flowchart 300 may be performed in different orders than shown. Flowchart 300 is described as follows with respect to FIGS. 1-2 for illustrative purposes.

Flowchart 300 starts at step 302. In step 302, a source region of a structured document is determined. For instance, AI assistant 202 determines source region 114 of structured document 112 in various ways. In instances, AI assistant 202 determines source region 114 by analyzing structured document 112, and detecting a relationship between content in source region 114 and content in destination region 116. In embodiments, AI assistant 202 determines source region 114 based on a user input 120 (e.g., user selection) provided via UI 104.

In step 304, a destination region of the structured document is determined. For instance, AI assistant 202 determines destination region 116 of structured document 112 in various ways. In instances, AI assistant 202 determines that content in destination region 116 of structured document 112 is derived from content in source region 114 through semantic analysis of structured document 112. In embodiments, AI assistant 202 determines destination region 116 based on a document type (e.g., patent application, scientific paper, etc.) of structured document 112 having a known structure (e.g., abstract, description, figures, claims, etc.) that allows relationships between regions of structured document 112 to be recognized. In configurations, a user may explicitly identify, via a user input 120, source region 114 and destination region 116 and indicate a relationship between source region 114 and destination region 116. In an embodiment, AI assistant 202 infers destination region 116 based on a user invoking an operation to generate output content 210 for destination region 116 using content in source region 114. In such a scenario, it may be inferred that content in destination region 116 should remain consistent with content in source region 114.

In step 306, a generative workflow object is embedded into the structured document, the generative workflow object maintaining contextual information for generating output content for the destination region based on input content from the source region. For instance, AI assistant 202 generates and embeds generative workflow object 118 in structured document 112. In embodiments, generative workflow object 118 maintains contextual information, such as, but not limited to, an input content used to generate the output content, a source region of the structured document comprising the input content, a transformation to apply to the input content to generate the output content, a destination region of the structured document associated with the output content, a content constraint for the output content, a parameter to tune the generation of the output content, historical interactions (e.g., prompt, response) with an AI model, user edits to the generated content, and/or the like.

In step 308, a first prompt is provided to an AI model to generate a first output content based on a first input content from the source region. For instance, prompt generator 204 provides prompt 128 to AI model(s) 108 to cause AI model(s) 108 to generate output content for destination region 116 based on content from source region 114.

In step 310, a first response is received from the AI model, the first response comprising the first output content. For instance, response validator 206 receives, from AI model(s) 108, response 130 that includes output content 210.

In step 312, the generative workflow object is updated based at least on the first prompt and the first response. For instance, AI assistant 202 updates generative workflow object 118 based on prompt 128 and/or response 130. Updated generative workflow object 118 stores derivation and/or transaction data memorializing the transformation of content from source region 114 into content for destination region 116. In embodiments, derivation and/or transaction data include, but are not limited to, workflow steps or tasks, historical interactions (e.g., chat history) with AI model(s) 108, a function (e.g., transformation) identifier, an input content (e.g., content from source region 114), an input identifier of source region 114, user feedback, and/or the like.

In step 314, the destination region is populated based at least on the first output content. For instance, AI assistant 202 populates destination region 116 with output content 210.

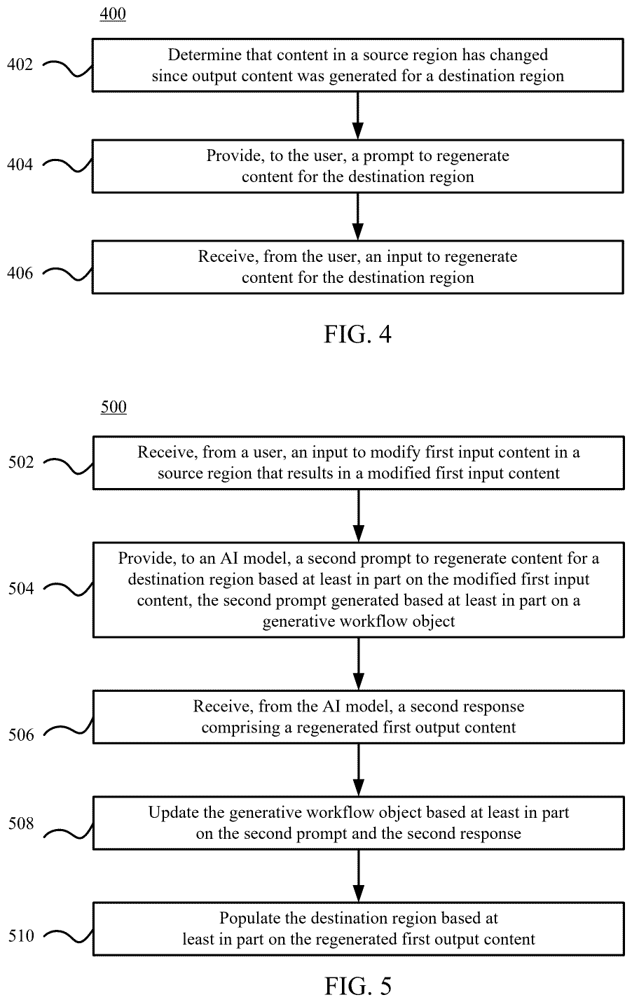

Embodiments described herein may operate in various ways to prompt a user to regenerate content for a destination region based on detection of changes to a source region. For example, FIG. 4 depicts a flowchart 400 for prompting a user to regenerate content for a destination region based on detection of changes to a source region, in accordance with an embodiment. Computing device(s) 102, application 106, AI assistant 202, prompt generator 204, and/or response validator 206 may operate in accordance with flowchart 400. Note that not all steps of flowchart 400 may need to be performed in all embodiments, and in some embodiments, the steps of flowchart 400 may be performed in different orders than shown. Flowchart 400 is described as follows with respect to FIGS. 1-2 for illustrative purposes.

Flowchart 400 starts at step 402. In step 402, it is determined that content in a source region has changed since output content was generated for a destination region. For instance, AI assistant 202 determines that content in source region 114 has changed since output content 210 last generated for destination region 116, such that content in destination region 116 is misaligned with the changed content in source region 114. In an embodiment, generative workflow object 118 stores a condensed semantic hash to facilitate the detection of changes to source region 114 of structured document 112. In another embodiment, AI assistant 202 determines whether a distance (e.g., cosine distance, Euclidean distance, etc.) between a first vector representation associated with a previous content in the source region and a second vector representation associated with a current content in the source region exceeds a distance threshold.

In embodiments, regions (e.g., source region 114, destination region 116, etc.) of structured document 112 may be represented by clustering vector representations associated with content in regions, and changes to the content of the regions can be tracked based on regions joining and/or departing a cluster. For instance, regions (e.g., source region 114, destination region 116, etc.) of structured document 112, such as, but not limited to, a paragraph, a section, a block of related elements (e.g., bulleted, numbered, sub-bulleted, and/or sub-numbered elements) may be semantically analyzed by generating vector representations for the regions, clustering the generated vector representations into semantic clusters by distances (e.g., cosine distance, Euclidean distance, etc.) between the generated vector representations, and analyzing the clusters to determine a relationship between source region 114 and destination region 116. In this way, a region (e.g., source region 114) of structured document 112 is designated as a source of truth for generating content for another region (e.g., destination region 116). In an embodiment, descriptive text, figures, summaries, and/or the like may, for example, describe the content of an associated (e.g., adjacent, proximate, etc.) region. Based on the analysis of the vector representation cluster, a relationship is identified between source region 114 and destination region 116 in a cluster, and a transformation operation that results in similar semantic relationship is determined.

In step 404, a prompt is provided to the user to prompt the user to regenerate content for the destination region. For instance, when AI assistant 202 determines that changes to the source region of the structured document satisfies a threshold condition (e.g., distance threshold, etc.), AI assistant 202 prompts a user to regenerate the content for the destination region.

In step 406, an input is received from the user to regenerate content for the destination region. For instance, AI assistant 202 receives, via UI 104, a user input 120 to regenerate output content 210 for destination region 116. In an embodiment, the user invokes regeneration of output content 210 based on generative workflow object 118 by indicating the changed content of source region 114 as an input upon recognizing that changes made in source region 114 should be reflected elsewhere (e.g., destination region 116) in structured document 112. AI assistant 202 can also employ natural language processing to detect that content in destination region 116 is no longer semantically aligned with the updated content of source region 114. AI assistant 202 may monitor content in source region 114 for changes, and changes to source region 114 that exceed a threshold condition (e.g., distance threshold) trigger the automatic regeneration of output content for destination region 116 based on generative workflow object 118, or trigger an alert to prompt the user to initiate the regeneration of output content for destination region 116. In an embodiment, a detected change to source region 114 may trigger AI assistant 202 to transmit a request to AI model(s) 108 to determine whether content in destination region 116 needs to be revised based on its relationship to the changed content of source region 114.

Embodiments described herein may operate in various ways to perform repeatable content generation using a generative workflow object stored in a structured document. For example, FIG. 5 depicts a flowchart 500 for performing repeatable content generation using a generative workflow object stored in a structured document, in accordance with an embodiment. Computing device(s) 102, application 106, AI assistant 202, prompt generator 204, and/or response validator 206 may operate in accordance with flowchart 500. Note that not all steps of flowchart 500 may need to be performed in all embodiments, and in some embodiments, the steps of flowchart 500 may be performed in different orders than shown. Flowchart 500 is described as follows with respect to FIGS. 1-2 for illustrative purposes.

Flowchart 500 starts at step 502. In step 502, an input is received from a user to modify first input content in a source region that results in a modified first input content. For instance, a user edits, via a user input 120 provided to application 106, content in source region 114 of structured document 112.

In step 504, a second prompt to an AI model to regenerate content for a destination region based on the modified first input content, the second prompt generated based at least in part on a generative workflow object. For instance, AI assistant 202 generates prompt 128 to request the regeneration of output content 210 by AI model(s) 108. AI assistant 202 provides prompt 128 to AI model(s) 108 to cause AI model(s) 108 to replay the transformation memorialized in generative workflow object 118 to regenerate updated output content 210 that is aligned with the modified content of source region 114. For example, AI assistant 202 queries AI model(s) 108 for a description of how to derive the original content in destination region 116 from the original content in source region 114, and replay this description when content in source region 114 changes to request regeneration of content for destination region 116 based on the description. When a user modifies content in source region 114 identified in generative workflow object 118, the input content stored by generative workflow object 118 is replaced (e.g., updated) and the output content is regenerated based on updated generative workflow object 118 by transmitting the modified content in source region 114 to AI model(s) 108.

In step 506, a second response is received from the AI model, the second response comprising a regenerated first output content. For instance, AI assistant 202 receives, from AI model(s) 108, a response 130 that includes updated output content 210 for destination region 116 that is generated based at least on the modified content of source region 114. In embodiments, modifications to the content of source region 114 causes an vector representation associated with source region 114 to depart from a vector-representation cluster, and AI model(s) 108 generate changes to the content of destination region 116 that enable the vector representations associated with source region 114 and destination region 116 rejoin the same cluster, thereby realigning the contents associated with source region 114 and destination region 116. The departure of the vector representation associated with source region 114 from the vector-representation cluster triggers AI assistant 202 to prompt, via UI 104, the user to implement the changes generated by AI model(s) 108 to content associated with destination region 116, the prompt providing (e.g., displaying) the generated changes as a recommendation to the user for selection (e.g., approval).

In step 508, the generative workflow object is updated based on the second prompt and the second response. For instance, AI assistant 202 updates generative workflow object 118 based on prompt 128 and/or response 130.

In step 510, the destination region is populated based at least in part on the regenerated first content. For instance, AI assistant 202 replaces the content of destination region 116 in structured document 112 with updated output content 210. In an embodiment, AI assistant 202 prompts the user, via UI 104, to approve the replacement of the content of destination region 116 with updated output content 210. The prompt enables the user to confirm (e.g., approve) the replacement of the content in destination region 116 with updated output content 210, to reject the replacement of the content in destination region 116 with updated output content 210, or to request a new transformation operation to regenerate output content 210 for destination region 116 based, optionally, on additional user input and/or instruction to guide the regeneration of output content 210 by AI model(s) 108.

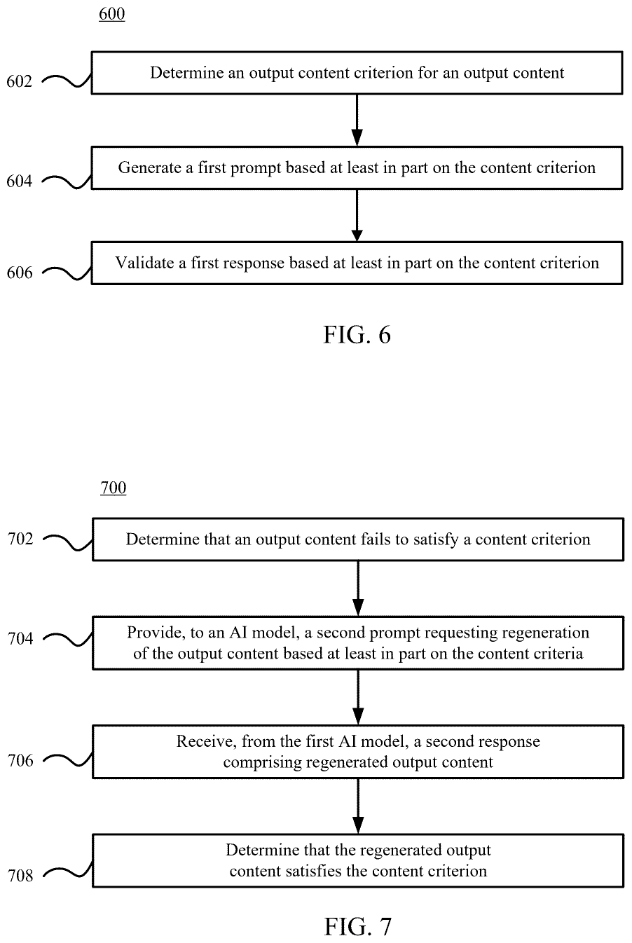

Embodiments described herein may operate in various ways to generate a prompt and validate a response based on a content criterion. For example, FIG. 6 depicts a flowchart 600 for generating a prompt and validating a response based on a content criterion, in accordance with an embodiment. Computing device(s) 102, application 106, AI assistant 202, prompt generator 204, and/or response validator 206 may operate in accordance with flowchart 600. Note that not all steps of flowchart 600 may need to be performed in all embodiments, and in some embodiments, the steps of flowchart 600 may be performed in different orders than shown. Flowchart 600 is described as follows with respect to FIGS. 1-2 for illustrative purposes.

Flowchart 600 starts at step 602. In step 602, an output content criterion is determined for an output content. For instance, AI assistant 202 determines a content criterion for destination region 116 based on generative workflow object 118. In embodiment, AI assistant 202 determines the content criterion in various ways, such as, but not limited to, based on a default content criterion in a default generative workflow object configuration, and/or based on user input.

In step 604, a first prompt is generated based on the content criterion. For instance, AI assistant 202 provides the content criterion in command 208 to prompt generator 204 to enable prompt generator 204 to generate prompt 128 for prompting AI model(s) 108 to generate output content 210 based on the content criterion.

In step 606, a first response is validated based on the content criterion. For instance, response validator 206 validates the output content generated by AI model(s) 108 based on the content criterion to determine whether the output content generated by AI model(s) 108 satisfies the content criterion.

Embodiments described herein may operate in various ways to validating a response from an AI model based on a content criterion. For example, FIG. 7 depicts a flowchart 700 for validating a response from an AI model based on a content criterion, in accordance with an embodiment. Computing device(s) 102, application 106, AI assistant 202, prompt generator 204, and/or response validator 206 may operate in accordance with flowchart 700. Note that not all steps of flowchart 700 may need to be performed in all embodiments, and in some embodiments, the steps of flowchart 700 may be performed in different orders than shown. Flowchart 700 is described as follows with respect to FIGS. 1-2 for illustrative purposes.

Flowchart 700 starts at step 702. In step 702, an output content is determined to fail to satisfy a content criterion. For instance, response validator 206 determines that the output content generated by AI model(s) 108 fails to satisfy a content criterion.

In step 704, a second prompt is provided to an AI model to request regeneration of the output content based on the content criterion. For instance, response validator 206 provides validation feedback 212 to prompt generator 204 to enable prompt generator 204 to provide a follow-up prompt to AI model(s) 108 to cause AI model(s) 108 to regenerate the output content based on the content criterion.

In step 706, a second response comprising regenerated output content is received from the AI model. For instance, response validator 206 receives a second response comprising regenerated output content from AI model(s) 108.

In step 708, the regenerated output content is determined to satisfy the content criterion. For instance, response validator 206 determines that the regenerated output content satisfies the content criterion.

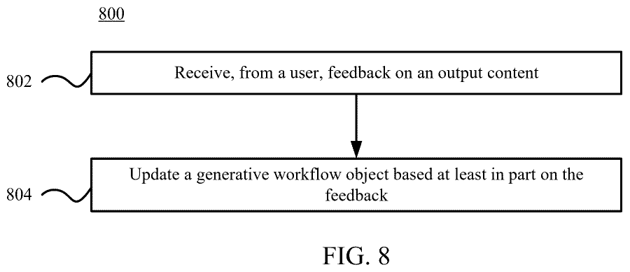

Embodiments described herein may operate in various ways to update a generative workflow object based on user feedback. For example, FIG. 8 depicts a flowchart 800 for updating a generative workflow object based on user feedback, in accordance with an embodiment. Computing device(s) 102, application 106, AI assistant 202, prompt generator 204, and/or response validator 206 may operate in accordance with flowchart 800. Flowchart 800 is described as follows with respect to FIGS. 1-2 for illustrative purposes.

Flowchart 800 starts at step 802. In step 802, feedback on output content is received from a user. For instance, AI assistant 202 receives, via UI 104, feedback associated with output content generated by AI model(s) 108. User feedback may include various user inputs 120, such as, but not limited to, an acceptance of generated output content, a rejection of generated output content, a modification (e.g., editing) of generated output content, a modification of a prompt (e.g., prompt and/or follow-up prompt 128), and/or the like.

In step 804, a generative workflow object is updated based on the feedback. For instance, AI assistant 202 updates generative workflow object 118 based on the user feedback. In embodiments, AI assistant 202 updates generative workflow object 118 to include indications of an acceptance of generated output content, a rejection of generated output content, a modification (e.g., editing) of generated output content, a modification of a prompt (e.g., prompt and/or follow-up prompt 128), and/or the like. AI assistant 202 employs updated generative workflow object 118 containing the user feedback future interactions with AI model(s) 108 to improve the likelihood of acceptance of output content by the user.

In an embodiment, AI assistant 202 may be operated by a user according to the following steps:
1. The user initiates content generation by selecting (e.g., clicking) an element (e.g., button) of UI 104 to generate the output content.
2. AI assistant 202 communicates input content associated with source region 114 to AI model(s) 108 in prompt 128 along with any context specified by any default generative workflow object configurations and/or user customizations in generative workflow object 118.
3. Response validator 206 receives the generated output content from AI model(s) 108 and processes the generated output content through any validations (e.g., content constraints) specified in generative workflow object 118.
4. If the output content does not pass validation, response validator 206 provides validation feedback 212 to prompt generator 204 to cause prompt generator 204 to communicate a follow-up prompt 128 to AI model(s) 108 to request correction of the invalid output content based on validation feedback 212.
5. Response validator 206 receives, from AI model(s) 108, a response with corrected (e.g., regenerated) output content, and performs validation again on the corrected output content. This back-and-forth process of providing a follow-up prompt to and receiving a corresponding response from AI model(s) 108 repeats until the output content generated by AI model(s) 108 successfully passes all validation checks and/or until a maximum configured number of iterations have been reached.
6. Once any validations have all passed and/or the maximum configured number of iterations has been reached, AI assistant 202 inserts the generated output content 210 into destination region 116 of structured document 112, and interactions with AI model(s) 108 conclude.
7. A user optionally reviews the generated output content and adjusts the inputs (e.g., content of source region 114), the initial prompt 128, and/or the context (e.g., content constraints, historical interactions with AI model(s) 108, etc.) provided in prompt 128 to cause AI model(s) 108 to make specific changes to the generated output content. The user may optionally make changes (e.g., edits, modifications, etc.) to the generated output content by selecting and/or editing the output content using the AI assistant.

### III. Example Mobile Device and Computer System Implementation

The systems and methods described above in reference to FIGS. 1-8, including computing device(s) 102, UI 104, application 106, AI model(s) 108, storage 110, structured document 112, source region 114, destination region 116, generative workflow object 118, AI assistant 202, prompt generator 204, response validator 206, and/or each of the components described therein, and/or the steps of flowcharts 300, 400, 500, 600, 700, and/or 800 may be implemented in hardware, or hardware combined with one or both of software and/or firmware. For example, UI 104, application 106, AI model(s) 108, storage 110, structured document 112, source region 114, destination region 116, generative workflow object 118, AI assistant 202, prompt generator 204, response validator 206, and/or each of the components described therein, and/or the steps of flowcharts 300, 400, 500, 600, 700, and/or 800 may be each implemented as computer program code/instructions configured to be executed in one or more processors and stored in a computer readable storage medium. Alternatively computing device(s) 102, UI 104, application 106, AI model(s) 108, storage 110, structured document 112, source region 114, destination region 116, generative workflow object 118, AI assistant 202, prompt generator 204, response validator 206, and/or each of the components described therein, and/or the steps of flowcharts 300, 400, 500, 600, 700, and/or 800 may be each implemented in one or more SOCs (systems-on-chips). An SOC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 9. FIG. 9 shows a block diagram of an exemplary computing environment 900 that includes a computing device 902. Computing device 902 is an example of computing device(s) 102 shown in FIG. 1, which may each include one or more of the components of computing device 902. In some embodiments, computing device 902 is communicatively coupled with devices (not shown in FIG. 9) external to computing environment 900 via network 904. Network 904 comprises one or more networks such as local area networks (LANs), wide area networks (WANs), enterprise networks, the Internet, etc., and may include one or more wired and/or wireless portions. Network 904 may additionally or alternatively include a cellular network for cellular communications. Computing device 902 is described in detail as follows.

Computing device 902 can be any of a variety of types of computing devices. For example, computing device 902 may be a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. Computing device 902 may alternatively be a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, one or more input devices 930, one or more output devices 950, one or more wireless modems 960, one or more wired interfaces 980, a power supply 982, a location information (LI) receiver 984, and an accelerometer 986. Storage 920 includes memory 956, which includes non-removable memory 922 and removable memory 924, and a storage device 990. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 930 includes a touch screen 932, a microphone 934, a camera 936, a physical keyboard 938, and a trackball 940. Not all components of computing device 902 shown in FIG. 9 are present in all embodiments, additional components not shown may be present, and any combination of the components may be present in a particular embodiment. These components of computing device 902 are described as follows.

A single processor 910 (e.g., central processing unit (CPU), microcontroller, a microprocessor, signal processor, ASIC (application specific integrated circuit), and/or other physical hardware processor circuit) or multiple processors 910 may be present in computing device 902 for performing such tasks as program execution, signal coding, data processing, input/output processing, power control, and/or other functions. Processor 910 may be a single-core or multi-core processor, and each processor core may be single-threaded or multithreaded (to provide multiple threads of execution concurrently). Processor 910 is configured to execute program code stored in a computer readable medium, such as program code of operating system 912 and application programs 914 stored in storage 920. The program code is structured to cause processor 910 to perform operations, including the processes/methods disclosed herein. Operating system 912 controls the allocation and usage of the components of computing device 902 and provides support for one or more application programs 914 (also referred to as “applications” or “apps”). Application programs 914 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 910 may include one or more general processors (e.g., CPUs) configured with or coupled to one or more hardware accelerators, such as one or more NPUs and/or one or more GPUs.

Any component in computing device 902 can communicate with any other component according to function, although not all connections are shown for ease of illustration. For instance, as shown in FIG. 9, bus 906 is a multiple signal line communication medium (e.g., conductive traces in silicon, metal traces along a motherboard, wires, etc.) that may be present to communicatively couple processor 910 to various other components of computing device 902, although in other embodiments, an alternative bus, further buses, and/or one or more individual signal lines may be present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 990, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 922 may include main memory and may be separate from or fabricated in a same integrated circuit as processor 910. As shown in FIG. 9, non-removable memory 922 stores firmware 918, which may be present to provide low-level control of hardware. Examples of firmware 918 include BIOS (Basic Input/Output System, such as on personal computers) and boot firmware (e.g., on smart phones). Removable memory 924 may be inserted into a receptacle of or otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 990 may be present that are internal and/or external to a housing of computing device 902 and may or may not be removable. Examples of storage device 990 include a hard disk drive, an SSD, a thumb drive (e.g., a USB (Universal Serial Bus) flash drive), or other physical storage device.

One or more programs may be stored in storage 920. Such programs include operating system 912, one or more application programs 914, and other program modules and program data. Examples of such application programs may include, for example, computer program logic (e.g., computer program code/instructions) for implementing UI 104, application 106, AI model(s) 108, storage 110, structured document 112, source region 114, destination region 116, generative workflow object 118, AI assistant 202, prompt generator 204, response validator 206, and/or each of the components described therein, as well as any of flowcharts 300, 400, 500, 600, 700, and/or 800, and/or any individual steps thereof.

Storage 920 also stores data used and/or generated by operating system 912 and application programs 914 as application data 916. Examples of application data 916 include web pages, text, images, tables, sound files, video data, and other data, which may also be sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 902 through one or more input devices 930 and may receive information from computing device 902 through one or more output devices 950. Input device(s) 930 may include one or more of touch screen 932, microphone 934, camera 936, physical keyboard 938 and/or trackball 940 and output device(s) 950 may include one or more of speaker 952 and display 954. Each of input device(s) 930 and output device(s) 950 may be integral to computing device 902 (e.g., built into a housing of computing device 902) or external to computing device 902 (e.g., communicatively coupled wired or wirelessly to computing device 902 via wired interface(s) 980 and/or wireless modem(s) 960). Further input devices 930 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 may display information, as well as operating as touch screen 932 by receiving user commands and/or other information (e.g., by touch, finger gestures, virtual keyboard, etc.) as a user interface. Any number of each type of input device(s) 930 and output device(s) 950 may be present, including multiple microphones 934, multiple cameras 936, multiple speakers 952, and/or multiple displays 954.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). Wireless modem 960 may also or alternatively include other radio-based modem types, such as a Bluetooth modem 964 (also referred to as a “Bluetooth device”) and/or Wi-Fi modem 962 (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 982, LI receiver 984, accelerometer 986, and/or one or more wired interfaces 980. Example wired interfaces 980 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 980 of computing device 902 provide for wired connections between computing device 902 and network 904, or between computing device 902 and one or more devices/peripherals when such devices/peripherals are external to computing device 902 (e.g., a pointing device, display 954, speaker 952, camera 936, physical keyboard 938, etc.). Power supply 982 is configured to supply power to each of the components of computing device 902 and may receive power from a battery internal to computing device 902, and/or from a power cord plugged into a power port of computing device 902 (e.g., a USB port, an A/C power port). LI receiver 984 may be used for location determination of computing device 902 and may include a satellite navigation receiver such as a Global Positioning System (GPS) receiver or may include other type of location determiner configured to determine location of computing device 902 based on received information (e.g., using cell tower triangulation, etc.). Accelerometer 986 may be present to determine an orientation of computing device 902.

Note that the illustrated components of computing device 902 are not required or all-inclusive, and fewer or greater numbers of components may be present as would be recognized by one skilled in the art. For example, computing device 902 may also include one or more of a gyroscope, barometer, proximity sensor, ambient light sensor, digital compass, etc. Processor 910 and memory 956 may be co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein may be stored in storage 920 and executed by processor 910.

In some embodiments, server infrastructure 970 may be present in computing environment 900 and may be communicatively coupled with computing device 902 via network 904. Server infrastructure 970, when present, may be a network-accessible server set (e.g., a cloud-based environment or platform). As shown in FIG. 9, server infrastructure 970 includes clusters 972. Each of clusters 972 may comprise a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. Any of nodes 974 may be a storage node that comprises a plurality of physical storage disks, SSDs, and/or other physical storage devices that are accessible via network 904 and are configured to store data associated with the applications and services managed by nodes 974. For example, as shown in FIG. 9, nodes 974 may store application data 978.

Each of nodes 974 may, as a compute node, comprise one or more server computers, server systems, and/or computing devices. For instance, a node 974 may include one or more of the components of computing device 902 disclosed herein. Each of nodes 974 may be configured to execute one or more software applications (or “applications”) and/or services and/or manage hardware resources (e.g., processors, memory, etc.), which may be utilized by users (e.g., customers) of the network-accessible server set. For example, as shown in FIG. 9, nodes 974 may operate application programs 976. In an implementation, a node of nodes 974 may operate or comprise one or more virtual machines, with each virtual machine emulating a system architecture (e.g., an operating system), in an isolated manner, upon which applications such as application programs 976 may be executed.

In an embodiment, one or more of clusters 972 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 972 may be a datacenter in a distributed collection of datacenters. In embodiments, exemplary computing environment 900 comprises part of a cloud-based platform.

In an embodiment, computing device 902 may access application programs 976 for execution in any manner, such as by a client application and/or a browser at computing device 902.

For purposes of network (e.g., cloud) backup and data security, computing device 902 may additionally and/or alternatively synchronize copies of application programs 914 and/or application data 916 to be stored at network-based server infrastructure 970 as application programs 976 and/or application data 978. For instance, operating system 912 and/or application programs 914 may include a file hosting service client configured to synchronize applications and/or data stored in storage 920 at network-based server infrastructure 970.

In some embodiments, on-premises servers 992 may be present in computing environment 900 and may be communicatively coupled with computing device 902 via network 904. On-premises servers 992, when present, are hosted within an organization's infrastructure and, in many cases, physically onsite of a facility of that organization. On-premises servers 992 are controlled, administered, and maintained by IT (Information Technology) personnel of the organization or an IT partner to the organization. Application data 998 may be shared by on-premises servers 992 between computing devices of the organization, including computing device 902 (when part of an organization) through a local network of the organization, and/or through further networks accessible to the organization (including the Internet). Furthermore, on-premises servers 992 may serve applications such as application programs 996 to the computing devices of the organization, including computing device 902. Accordingly, on-premises servers 992 may include storage 994 (which includes one or more physical storage devices such as storage disks and/or SSDs) for storage of application programs 996 and application data 998 and may include one or more processors for execution of application programs 996. Still further, computing device 902 may be configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 may be used to implement systems, clients, devices, and/or components/subcomponents thereof, disclosed elsewhere herein. In other embodiments, a combination of computing device 902, network-based server infrastructure 970, and/or on-premises servers 992 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 914) may be stored in storage 920. Such computer programs may also be received via wired interface(s) 980 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments but should be defined only in accordance with the following claims and their equivalents.

What is claimed is:

1. A system comprising:
a processor; and
a computer-readable storage medium comprising executable instructions that, when executed by the processor, cause the processor to:
determine a source region of a structured document;
determine a destination region of the structured document, the destination region different from the source region;
embed, in the structured document, a generative workflow object that maintains contextual information for generating output content for the destination region based on input content from the source region;
provide, to an artificial intelligence (AI) model, a first prompt to generate a first output content based at least in part on a first input content from the source region;
receive, from the AI model, a first response comprising the first output content;
update the generative workflow object based at least in part on the first prompt and the first response; and
populate the destination region based at least in part on the first output content.

2. The system of claim 1, wherein the executable instructions, when executed by the processor, further cause the processor to:
receive, from a user, a first user input to modify the first input content that results in a modified first input content;
provide, to the AI model, a second prompt to regenerate content for the destination region based at least in part on the modified first input content, the second prompt generated based at least in part on the generative workflow object;
receive, from the AI model, a second response comprising a regenerated first output content;
update the generative workflow object based at least in part on the second prompt and the second response; and
populate the destination region based at least in part on the regenerated first output content.

3. The system of claim 2, wherein, to provide, to the AI model, the second prompt to regenerate content for the destination region, the executable instructions, when executed by the processor, cause the processor to:
determine that content in the source region has changed since the first output content was generated;
provide, to the user, a prompt to regenerate content for the destination region; and
receive, from the user, a second user input to regenerate content for the destination region.

4. The system of claim 1, wherein the executable instructions, when executed by the processor, further cause the processor to:
determine a content criterion for the first output content;
generate the first prompt based at least in part on the content criterion; and
validate the first response based at least in part on the content criterion,
wherein the content criterion comprises at least one of:
a word limit for the first output content, or
a transformation to apply to the first input content to generate the first output content.

5. The system of claim 4, wherein, to validate the first response based at least in part on the content criterion, the executable instructions, when executed by the processor, cause the processor to:
determine that the first output content fails to satisfy the content criterion;
provide, to the AI model, a second prompt requesting regeneration of the first output content based at least in part on the content criterion;
receive, from the AI model, a second response comprising a regenerated first output content; and
determine that the regenerated first output content satisfies the content criterion.

6. The system of claim 1, wherein the executable instructions, when executed by the processor, further cause the processor to:
receive, from a user, user feedback on the first output content; and
update the generative workflow object based at least in part on the user feedback.

7. The system of claim 6, wherein, to receive, from the user, the user feedback, the executable instructions, when executed by the processor, cause the processor to:
receive, from the user, an edit to modify the first output content that results in a modified first output content.

8. A method comprising:
determining a source region of a structured document;
determining a destination region of the structured document that is different from the source region;
embedding, in the structured document, a generative workflow object that maintains contextual information for generating output content for the destination region based on input content from the source region;
providing, to an artificial intelligence (AI) model, a first prompt to generate a first output content based at least in part on a first input content from the source region;
receiving, from the AI model, a first response comprising the first output content;
updating the generative workflow object based at least in part on the first prompt and the first response; and
populating the destination region based at least in part on the first output content.

9. The method of claim 8, further comprising:
receiving, from a user, a first user input to modify the first input content that results in a modified first input content;
providing, to the AI model, a second prompt to regenerate content for the destination region based at least in part on the modified first input content, the second prompt generated based at least in part on the generative workflow object;
receiving, from the AI model, a second response comprising a regenerated first output content;
updating the generative workflow object based at least in part on the second prompt and the second response; and
populating the destination region based at least in part on the regenerated first output content.

10. The method of claim 9, wherein said providing, to the AI model, the second prompt to regenerate content for the destination region comprises:
determining that content in the source region has changed since the first output content was generated;
providing, to the user, a prompt to regenerate content for the destination region; and
receiving, from the user, a second user input to regenerate content for the destination region.

11. The method of claim 8, further comprising:
determining a content criterion for the first output content;
generating the first prompt based at least in part on the content criterion; and
validating the first response based at least in part on the content criterion,
wherein the content criterion comprises at least one of:
a word limit for the first output content, or
a transformation to apply to the first input content to generate the first output content.

12. The method of claim 11, wherein said validating the first response based at least in part on the content criterion comprises:
determining that the first output content fails to satisfy the content criterion;
providing, to the AI model, a second prompt requesting regeneration of the first output content based at least in part on the content criterion;
receiving, from the AI model, a second response comprising a regenerated first output content; and
determining that the regenerated first output content satisfies the content criterion.

13. The method of claim 8, further comprising:
receiving, from a user, user feedback on the first output content; and
updating the generative workflow object based at least in part on the user feedback.

14. The method of claim 13, wherein said receiving, from the user, the user feedback comprises:
receiving, from the user, an edit to modify the first output content that results in a modified first output content.

15. A computer-readable storage medium comprising executable instructions that, when executed by a processor, cause the processor to:
determine a source region of a structured document;
determine a destination region of the structured document, the destination region different from the source region;
embed, in the structured document, a generative workflow object that maintains contextual information for generating output content for the destination region based on input content from the source region;
provide, to an artificial intelligence (AI) model, a first prompt to generate a first output content based at least in part on a first input content from the source region;
receive, from the AI model, a first response comprising the first output content;
update the generative workflow object based at least in part on the first prompt and the first response; and
populate the destination region based at least in part on the first output content.

16. The computer-readable storage medium of claim 15, wherein the executable instructions, when executed by the processor, further cause the processor to:
receive, from a user, a first user input to modify the first input content that results in a modified first input content;
provide, to the AI model, a second prompt to regenerate content for the destination region based at least in part on the modified first input content, the second prompt generated based at least in part on the generative workflow object;
receive, from the AI model, a second response comprising a regenerated first output content;
update the generative workflow object based at least in part on the second prompt and the second response; and
populate the destination region based at least in part on the regenerated first output content.

17. The computer-readable storage medium of claim 16, wherein, to provide, to the AI model, the second prompt to regenerate content for the destination region, the executable instructions, when executed by the processor, cause the processor to:
determine that content in the source region has changed since the first output content was generated;
provide, to the user, a prompt to regenerate content for the destination region; and
receive, from the user, a second user input to regenerate content for the destination region.

18. The computer-readable storage medium of claim 15, wherein the executable instructions, when executed by the processor, further cause the processor to:
determine a content criterion for the first output content;
generate the first prompt based at least in part on the content criterion; and
validate the first response based at least in part on the content criterion,
wherein the content criterion comprises at least one of:
a word limit for the first output content, or
a transformation to apply to the first input content to generate the first output content.

19. The computer-readable storage medium of claim 18, wherein, to validate the first response based at least in part on the content criterion, the executable instructions, when executed by the processor, cause the processor to:
determine that the first output content fails to satisfy the content criterion;
provide, to the AI model, a second prompt requesting regeneration of the first output content based at least in part on the content criterion;
receive, from the AI model, a second response comprising a regenerated first output content; and
determine that the regenerated first output content satisfies the content criterion.

20. The computer-readable storage medium of claim 19, wherein the executable instructions, when executed by the processor, further cause the processor to:
receive, from a user, user feedback on the first output content, the user feedback comprising an edit to modify the first output content that results in a modified first output content; and
update the generative workflow object based at least in part on the user feedback.
